(19) United States
(12) Patent Application Publication
(10) Pub. No.: US 2012/0020649 A1
(43) Pub. Date: Jan. 26, 2012

(54) METHOD AND APPARATUS TO CONVEY VISUAL PHYSICAL ACTIVITY INSTRUCTIONS ON A VIDEO SCREEN

(76) Inventor: Michael Vanderkaden, Toronto (CA)

(21) Appl. No.: 13/186,965

(22) Filed: Jul. 20, 2011

Related U.S. Application Data
(60) Provisional application No. 61/365,875, filed on Jul. 20, 2010.

(51) Int. Cl. G11B 27/00

(52) U.S. Cl. 386/280; 386/285; 386/E05.028

(57) ABSTRACT

A process for adapting an exercise video for utilization as a non-audible exercise video comprising selecting an exercise video, and incorporating visual instructions into said exercise video, whereby the visual instructions are selected to comprise a coherent series of non-audio instructions. Also taught are a video recording of the invention, a process for programming a coordinated video transmission and presentation, and a portable device for providing vibration corresponding to an event in the exercise video.

### CROSS REFERENCE TO RELATED APPLICATION

This application claims priority from U.S. Provisional Application No. 61/365,875 filed Jul. 20, 2010. The entire disclosure of the abovementioned application is hereby incorporated herein by reference.

### TECHNICAL FIELD

This invention relates to physical exercise video systems, and in particular to video systems which are adapted for use without audio and presented with regular video content.

### BACKGROUND

For years, people have recognized the health benefits of exercise and stretching. As a result, many exercise instruction systems have been introduced, including books, videos, audio recordings, and posters, to name but a few. These devices typically engage users in series of exercise activities, such as poses, motions, lifting, pedaling, stepping, pulling or running, by verbal instruction.

Despite the many benefits of exercise, some users find it tedious or boring or lack the time or motivation to engage in exercise, and this has discouraged many from regular exercise. Coincidentally, while some people shunned exercise, a large portion of the population became television and video game enthusiasts. This development did not go unnoticed by the exercise equipment industry, which over the years has attempted to make exercise more interesting by associating it with some form of visual entertainment, particularly television, computer and Internet-based activities, wireless devices or video games. And although there have been many attempts to meld exercise and video, none of these efforts have yielded completely satisfactory results.

It is no wonder then that a large number of people exercise regularly by joining health clubs, purchasing specialized home fitness equipment, engaging in exercise poses, motions and stretches, jogging, walking or bicycling, undertaking recreational activities that provide exercise benefits, and the like. Unfortunately, it is not uncommon for people to undertake an exercise program, only to abandon the program a short time later, usually before any meaningful improvements have been achieved. Often, this is a recurring problem for a particular individual.

There are countless reasons why people drop out of an exercise program. Boredom, forgetfulness, lack of time, lack of motivation and inability to sustain a routine is often cited as a reason why people abandon an exercise program. Also, some view the act of exercising as work rather than a leisure activity.

Many people prefer to exercise at home rather than at a health club. In particular, the people most in need of an exercise program are also the people most likely to feel uncomfortable at a health club. Unfortunately, the home exerciser is usually not inclined to discuss his or her fitness objectives with a professional trainer, doctor, or physical therapist and is, therefore, likely to spend money on exercise equipment which is ineffective for producing the results desired by the individual. Many home exercisers also purchase instructional exercise videos which all too often fail to motivate the user, who become distracted by other home based activities, to maintain an ongoing exercise routine. Purchasing ineffective equipment and unused instructional videos are not only a waste of money, it also leads to discouragement and the subsequent abandonment of the exercise program.

There is, therefore, a need for training material which directs a potential exerciser as to the proper exercises to achieve a desired result; provides instruction for exercising at different intensity levels; entertains the exerciser to reduce boredom; appeals to a home user; aids the user in finding the time to exercise and in the establishment and sustenance of an ongoing exercise routine; and does not require an undue investment in specialized equipment.

By way of background, commercially available instructional videos rely extensively on verbal cues to lead a person through an activity. While focused on the verbal cues, the individual is not able to be simultaneously entertained by other methods which incorporate audio, such as video or music. It is thus an object of the present invention to provide an instructional exercise video which presents instruction and multiple exercise movements such that an exerciser may achieve a desired result while exercising at an intensity appropriate to the condition of the exerciser. The further objective of this system is that the ability to pair the instructional exercise video with other video or audio entertainment programs in such a way so as to allow the user to be entertained while exercising, to find the time to exercise, to schedule exercise sessions in advance, and to maintain an exercise routine over on period of time such that the cumulative benefits of repeated exercise are realized.

### DISCLOSURE OF INVENTION

In accordance with the invention a flexible and powerful communication system is provided that will result in substantial communication from the activity video to the user, without the need for audio. One object of the invention is to provide an exercise video system having non audible communication to the user. This enables the user to carry out other activities while following the activity video, such as watching television, watching videos or entertainment on a computer, laptop, or wireless devices such as the iPad, iPhone, or Blackberry, performing simple work or leisure tasks, or listening to music of choice. The video system is preferably utilized using a conventional television as a display, either via a picture in picture video functionality or programmable “widgets” which allow for the simultaneous presentation of content in the latest generation of internet-enabled televisions. However, other video systems can be used, including simultaneous transmission, video over the Internet, or simultaneous display on one or more computers, of both an entertainment focused video and audio and the Non-Audio Exercise Video (NAEV) system. In addition, the NAEV could be viewed by those engaged in mundane activities like a phone call such that they can get the benefit of simple exercise, particularly therapeutic exercise focused on a specific body part, at the same time.

In one embodiment, the invention comprises a process for adapting an exercise video for utilization as a non-audible exercise video comprising selecting an exercise video, and incorporating visual instructions into said exercise video, whereby the visual instructions are selected to comprise a coherent series of non-audio instructions.

In another embodiment, the invention comprises an article of manufacture comprising a device containing a video recording, wherein the video recording is an exercise video incorporating visual instructions into the exercise video, whereby the visual instructions comprise a coherent series of non-audio instructions.

In a further embodiment, the invention teaches a process for programming a coordinated video transmission comprising programming a first video for audio-visual uptake by a user and coordinating transmission of the first video with the programming of an exercise video comprising visual instructions, whereby the visual instructions are selected to comprise a coherent series of non-audio instructions.

The invention encompasses the exercise video prepared to be viewed in a size viewable on a small screen. The small screen may be a sub screen portion of larger television or computer display. The visual instructions may comprise symbols including words, letters, numbers and graphical overlays such as arrows, lines and other graphics to provide guidance on the proper execution and progression of an exercise. The visual instructions may further comprise a color code or symbol indication as to intensity level or an indication as to level of difficulty. The visual instructions may further comprise a color overlay indicating which muscles to contract and/or relax. The indication may comprise a flashing screen to indicate a change in the visual instructions. The visual instructions may further comprise an indication of the amount of the routine remaining or progress achieved. The invention may further encompass written instructions in letters which are large in relation to the size of the small screen. The written instructions may be selected to be written in letters which are 20% to 50% in height in proportion to the size of the small screen. Alternatively, the written instructions may be written in letters which are 20% to 35% in height in proportion to the size of the screen. In an embodiment, the exercise video may be broadcast simultaneously through a device separate from an entertainment video.

The invention also comprises a process wherein the exercise video and the first video are broadcast simultaneously as a single program with two views. In another embodiment, the invention comprises a process wherein the exercise video and the first video are broadcast independently but shown simultaneously on the receiving display(s). In another embodiment, the invention comprises a process or article wherein the visual instructions further comprise vibrating or bouncing video displayed on the small screen. In yet another embodiment, the invention comprises a process or article wherein instructions further comprise vibration of a portable device attached to a body of a user of the exercise video, wherein the portable device provides vibration as a signalling mechanism, the vibration corresponding to an event in the exercise video.

### BRIEF DESCRIPTION OF DRAWINGS

FIG. 1 is a perspective view of a system in accordance with the invention having a video system and picture in picture module showing detail of the instructions;

FIG. 2 is a perspective view of a system in accordance with the invention having a video system with simultaneous broadcast or overlaying one video over another;

FIG. 3 is a temporal series of diagrams of a duration marker of the system of FIG. 2;

FIG. 4 is a perspective view of a system in accordance with the invention having two separate video systems; and

FIG. 5 is a flowchart of instructions of the NAEV system of FIG. 1.

### DETAILED DESCRIPTION OF PREFERRED EMBODIMENTS

The present inventor has created a synergy between modern video devices and novel non-verbal sets of instructions for use in teaching, motivating and maintaining exercise and/or stretching routines.

Exercise videos, on DVD, PVR, or over the internet, are popular. Watching non-exercise (i.e. purely entertaining television and video based entertainment) is even more popular. Studies show that television watchers are often less than fully engaged while watching television leading them to frequently engage in other activities (Internet surfing, emails) at the same time. While many individuals say they do not have time to exercise they nonetheless do find time to watch television or other video based entertainment. Individuals are conflicted between what they want to do (e.g. watching television) and what they should do (e.g. exercise, stretch). The present invention combines these two activities, so that no choice is necessary. The individual can exercise while enjoying their favourite television programs.

Thus the present invention can provide the following benefits: (i) being entertained while exercising, (ii) allowing for simultaneous exercise and entertainment or other activities allows for individuals to in effect create the time to exercise by enabling multi-tasking, (iii) linking exercise to entertainment, particularly televisions shows and sporting events, allows for creation of an exercise schedule and sustenance of an exercise routine, (iv) provides instruction for exercising at progressively higher intensities (v) appeals to a home user, allowing for more convenient and frequent exercise at a lower cost than a gym membership; (vi) does not require an undue investment in specialized equipment.

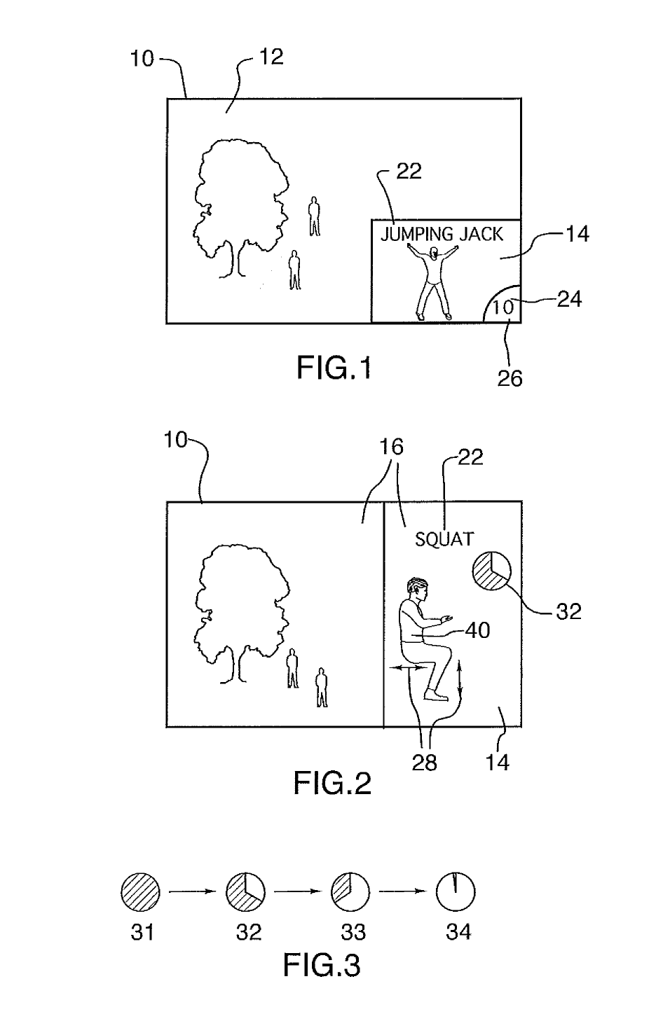

Many televisions today have split screen capability, either via a picture in picture (PIP) functionality or programmable internet connected devices which allow for the simultaneous presentation of content. As shown in FIG. 1, television 10 comprises a screen 12. When split screen capability is activated, a small sub screen 14 is viewed as well as the programming on screen 12. Audio corresponding to screen 12 continues to play. No audio corresponding to sub screen 14 is heard.

Preferably, the video will be tightly focused on only one or two actors, instructors or animations, making frequent use of zoom and avoiding wide angle, excessive panning, and larger groups of actors. These factors, alone or in combination, facilitates non-audible instruction, particularly if viewed on a small screen or subscreen. Existing exercise videos could be watched on sub screen 14. However, none of the audio instructions on which these videos rely would be heard. Such videos typically lack written or symbolic instruction, and any written words or symbols which may occur onscreen would be sized for a normal television screen (e.g. 20-50 inches or more). When shown on sub screen 14, any written words or symbols of a prior art exercise video would be too small to be comprehendible by the viewer. Thus a viewer, watching a prior art exercise video on the sub screen without audio, would not be able to comprehend and follow the exercise routine.

The present invention overcomes this difficult by providing symbols and written words which effectively convey the steps and routines of a demonstrative video, even when viewed in a sub screen or a smaller computer or portable device screen. For example, in FIG. 2, sub screen 14 comprises large lettering 16, which can be read on a sub screen, allowing the user to read and understand the present or upcoming routine or action. Sub screen 14 can also provide a visual of an actor 40 or an animated character performing the exercise routines, so that the user can follow along.

While exercise videos of the prior art often include at least some written words (e.g. opening and closing credits, closed caption for the hearing impaired), such words are not legible or barely legible on the sub screen of the picture in picture. In contrast, the present invention provides words in large font, large enough to be easily read and comprehended when on the sub screen. Large lettering, as used herein, refers to letters which are consistently about at least 20%-50% in height as compared to the height of the screen, preferably about 20%, 30% or 35%.

In addition, the placement of words, letters and symbols can be in non traditional locations, for example directly overlaid on top of fitness model, scrolling across the centre of the screen, etc.

Importantly, the use of symbols and other non-language based information is particularly desirable for at least three reasons. First, it can be readily viewed and discerned on a smaller screen, such as a split screen view, or a mobile screen device, while exercising. Secondly, it can be used by anyone, regardless of their language and regardless of their reading ability. Third, it allows exercise instruction to be more fully communicated in contexts where audio instruction is not desirable. In contrast, prior art exercise videos make limited use of symbols and non-language based information since they rely on verbal instruction and audio cues.

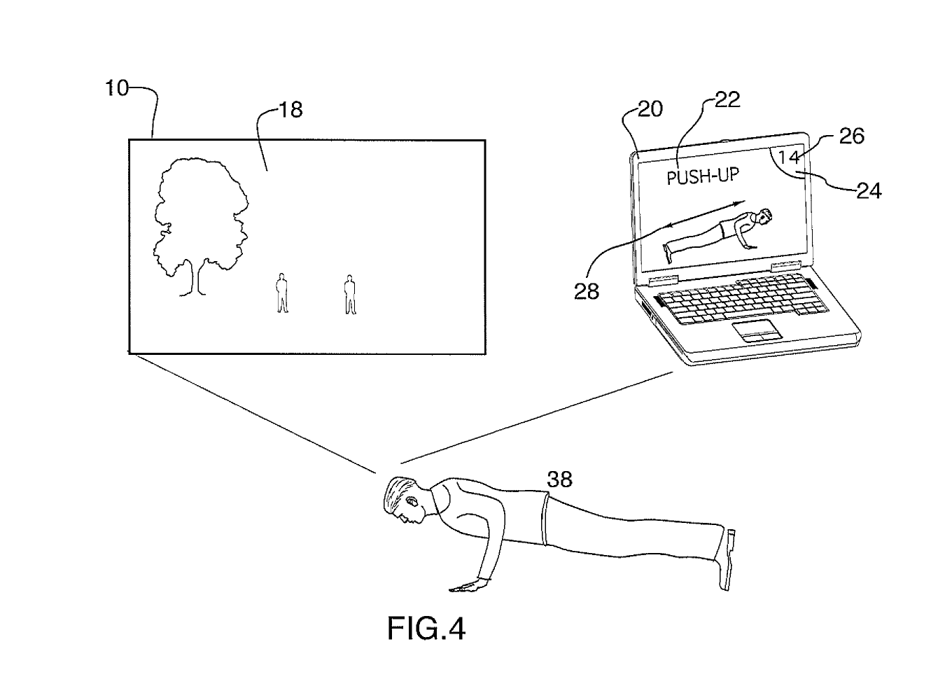

As shown in FIGS. 2 and 3, duration marker 31-34 indicates to the user how much time has elapsed since the start of the routine, and how much time is left. Alternatively or in addition, repetition marker 20 shown in FIGS. 1 and 4 indicates to the user how many repetitions of a routine have occurred since the start of the routine, and how many repetitions are left. Markers 26 and 31-34 is sized and position such at the user can readily view the markers even when viewed on sub screen 14.

Colors can be used to convey the intensity or difficulty of the routine. For example, green could represent easy, low level repetitions. Orange could be used to represent mid-level, mid-level of difficulty. Red could be used to represent the most difficult, advanced routines. The colours could be conveyed through the background of the video, a shape or other symbols including letters and words. Alternatively, or in addition, the colours could be conveyed through time marker 20. For example, an exercise, e.g. push-ups, could be shown on the screen. For the first 5 push ups, the time marker is green, indicating those wishing to follow an easier routine should follow along. For the next 10 push ups, the time marker is orange, indicating that those wishing to follow a mid level routine should continue to follow along. For the next 10 push ups after that, the time marker is read, indicating an advanced routine.

Other visual cues can be utilized. For example, software can be used to insert lines, curves or shapes into the video. For example, bright white lines can be placed to help show the user where their limbs should be positioned. Another use for the lines can be to direct the user as to the proper stance when exercising, for example, straightened back or curved back. This encourages safe, accurate positions during exercise.

In addition, colour overlays could be used to indicate when and which muscle groups should be engaged in contraction or relaxed and resting. For example a red overlay could be placed on contracting muscles, and a blue overlay could be placed on relaxing muscles. Other colors, of course, can be used.

Screen shifting can be used—moving the video up and down or back and forth to give the opinion that the screen is bouncing or vibrating, thus directing and encouraging the viewer to move likewise.

The flashing of light intensity or colors on the screen or a portion thereof is an important visual clue. One difficulty encountered in exercising while performing an additional task (for example, watching a movie) is that it becomes easy to be distracted, not noticing when the exercise routine has been changed. Thus, flashing can be utilized to draw the user's attention to the end of one part of the routine and the commencement of another.

FIG. 4 is a perspective view of a system in accordance with the invention having two separate video systems, one a television 10 showing conventional video programming 18 and the other a laptop computer 20 showing the NAEV, with both video streams being viewed by an individual 38 who is exercising and being entertained;

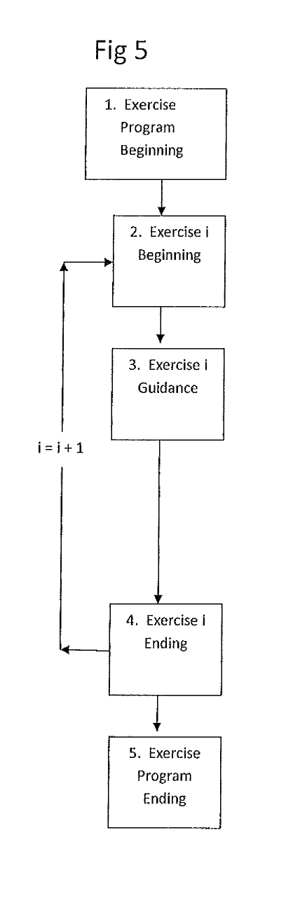

FIG. 5 is a flowchart showing the method of preparing and following a NAEV instruction. In step 1, the activity program commences with, for example a written or symbolic display and/or flashing of specific colors to draw attention to screen and signal the beginning of the program. For example, words can be used to signify name of program. An exercise program number may be displayed. All of the equipment required to perform the routine may be listed, both visually and/or in words. A list of instructions and warnings relating to the entire exercise routine may appear in written form to help reduce the risk of injury and increase the effectiveness of the pending activity.

In step 2, the activity program provides a flash of specific colors, vibration of the sub screen and/or vibration of a sensor located next to the skin of the participant to draw attention to screen and signal beginning of new exercise activity i, where i is an integer from 1 to the total number of exercises in the program. “Exercise”, as used herein, encompasses motions, poses, stretches, etc. Words or symbols can be used to signify the name of exercise, and/or an exercise number may be given. Specific instructions and warnings for the exercise could appear in written form to help reduce the risk of injury and increase the effectiveness of the pending activity.

Step 3 provides guidance in carrying out the activity, through the use of one or more of the following elements:

Words to describe exercise and/or number to indicate exercise number
Exercise duration indicator (see FIG. 3 and FIG. 2, part 32) which counts time of exercise (countdown to zero or count up to a specific number). Indicator can be color coded and/or change shapes to reflect changing difficultly associated with increased duration of exercise
Words, colour coding and/or shapes to signify difficulty of exercise program
Exercise Repetition Marker (see FIG. 1. Part 26) which counts the number of repetitions of a given exercise (countdown to zero or count up to a specific number). Indicator can be color coded and/or change shapes to reflect changing difficultly associated with increased repetition of exercise
Graphical overlays (arrows, lines, curves, etc.) to provide guidance on proper exercise form, positioning, and technique (see FIG. 2, part 28)
Words to provide further guidance, encouragement, instruction and warnings
The use of non-traditional positioning and orientation of written letters, for example, a vertical coloured line on a body part, such as the back, with the word STRAIGHT along that line
Graphic overlays or colour coding to indicate “inhale” and “exhale” instructions, for example pink for inhale and blue for exhale
Motivational components could also be interspersed with the exercise instruction to help the user maintain their focus and complete the exercise to the best of their ability. For example, video of an actor with highly toned and conditioned abdominal muscles could be used to encourage the viewer of an abdominal muscle routine to continue to exert effort.

Step 4 teaches that the exercise subroutine is ending. For example, a display of specific colors and/or use of written words to signal ending of exercise activity i.

Step 5 indicates the end of the exercise session. For example, a flash of specific colors to draw attention to the screen and signal the end of the program. Written words can also be used to signify the ending of program.

While the present invention is particularly suited to, for example, split screen use, other related uses are contemplated in other embodiments. For example, the videos so produced will be of use to those with hearing impairments, or those who have trouble reading due to visual or educational issues.

While the inventive method has been described hereinbefore as incorporating an on-screen informational display as a preferred embodiment, the invention is not necessarily so limited. The inventive method may be practiced without numeric or textual instruction, relying instead on visual cues elsewhere in the display to alert the user as the exercise movements change, so long as the cues are visible when projected.

The user may perform the exercise movements at the pace demonstrated in the video program, while being entertained by regular television. Alternately, one could watch and follow the exercise video while the user provides her or his own music selection while practicing the inventive method. A user may select music of their own preference which has a tempo which encourages a pace suited to the fitness level of the individual while performing the exercise movements.

While the present disclosure focuses on the use of the present methods and devices to convey instructions for exercise, it will be appreciated the instructions for related activities can likewise be conveyed, e.g. stretching, yoga, or martial arts. As used herein, the term “exercise” encompasses cardiovascular training, weight training, stretching, yoga, martial arts training, calisthenics, conditioning, warm-ups and the like.

While the NAEV is designed for use without supporting audio, it will be appreciated that the video can be supplied with normal audio instructions. For example, the first few times the user plays the video, they may want to view it with audible instruction, until they are familiarized with the routine.

Further, it should be clear to those skilled in the art that although the preferred embodiment involves the fixation of a set of synchronized exercise movements and visual cues on video tape, DVD, or other storage medium for subsequent replay, that is not an absolute requirement of the instant invention. For example, it would be possible to broadcast an embodiment of the instant invention that has been constructed “live” by using multiple cameras to capture multiple exercisers who are performing synchronized exercises of different movements. Modern video editing and broadcasting technology being what it is, methods of simultaneously displaying two or more live video signals on a single display device are conventional and well known to those skilled in the art. Additionally, broadcasters using the present invention are able to simultaneously broadcast live or pre-recorded NAEV in conjunction with other programming as directed by a viewer at that time or as pre-programmed in advance. Additionally, using internet-based video content providers (e.g. Hulu, Netflix, YouTube), an end user can choose to watch pair regular video content with NAEV via an program or interface on their television or computer at that time or as pre-programmed in advance.

In other embodiments, the invention need not combine two videos, one non-audible exercise and one audible. In this embodiment, the invention teaches simultaneous video watching of a non-audio exercise instruction in coordination with engagement in routine activities which do not preclude exercise but which do preclude audio instruction. Thus in this embodiment the invention combines exercise video which one can follow along with while listening to music, the news, or participating in a telephone or conference call, or any other activity where full attention is not necessary and thus the user can engage in a secondary activity, namely exercise. This would be particularly helpful for therapeutic exercises focused only on an isolated body part (e.g. ankle exercises for an ankle sprain).

Importantly, in another embodiment, the present invention encompasses methods of scheduling or programming. Thus the present invention provides a method for simultaneously combining non-audio exercise video instruction with regular video content. The exercise and video watching could be prescheduled through a broadcaster, either a network or a cable or satellite provider under this method, or with an internet-based video distribution service The non-audio exercise video instruction could also be scheduled on a computer to coincide with display of regular video content. Thus the pairing and scheduling of non-audio exercise instruction with regular video programming is provided, without the end user needing to have and operate picture in picture or having to operate two different video devices, enabling the user to in effect preschedule exercise sessions utilizing non-audio exercise instruction.

In a further embodiment, the invention encompasses a device with embedded vibration functionality such as a cellular telephone or a purpose built device structured to be worn close to the skin of an individual. The vibration functionality can be signaled wirelessly or otherwise by a computer which is also controlling or otherwise linked to the playing of the NAEV. The computer will be programmed to trigger the vibration functionality on the portable device at instances where key instructions are being conveyed via the NAEV, thus drawing the user's full attention to the NAEV.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

| | |
|---|---|
| Television or video display screen | 10 |
| Portion of screen displaying conventional video programming | 12 |
| Sub screen displaying non-audio exercise video (NAEV) | 14 |
| Television or video display screen displaying simultaneously | 16 |
| broadcast conventional programming and NAEV | |
| Conventional video programming | 18 |
| Laptop computer displaying NAEV | 20 |
| Written words | 22 |
| Difficulty color coding | 24 |
| Repetition count (changing color to reflect increasing level of | 26 |
| difficulty as repetitions increase) | |
| Instructional overlay | 28 |
| Duration marker (changing color to reflect level of difficultly as | 30-34 |
| duration increases) | |

We claim:

1. A process for adapting an exercise video for utilization as a non-audible exercise video, the process comprising the step of:
selecting an exercise video, and incorporating visual instructions into said exercise video, whereby the visual instructions are selected to comprise a coherent series of non-audio instructions, wherein the exercise video is displayed simultaneously or in conjunction with audio video content.

2. The process of claim 1, wherein the exercise video is prepared to be viewed in a size viewable on a small screen.

3. The process of claim 2, wherein the small screen is a sub screen portion of a larger video display view.

4. The process of claim 1, wherein the visual instructions comprise symbols.

5. The process of claim 1, wherein the visual instructions further comprise a color code or symbol indication as to intensity level or an indication as to level of difficulty.

6. The process of claim 1, wherein the visual instructions further comprise a color overlay indicating which muscles to contract and/or relax.

7. The process of claim 1, wherein the indication comprises a flashing screen or colors to indicate a change in the visual instructions

8. The process of claim 1, wherein the visual instructions further comprise an indication of the amount of the routine remaining or progress achieved.

9. The process of claim 3, further comprising written instructions in letters which are large in relation to the size of the small screen.

10. The process of claim 9, wherein the written instructions are written in letters which are 20% to 50% in height in proportion to the size of the small screen.

11. The process of claim 10, wherein the written instructions are written in letters which are 20% to 35% in height in proportion to the size of the screen.

12. A process for programming a coordinated video transmission and presentation, the process comprising the step of:
programming a first video for audio-visual uptake by a user and coordinating transmission of the first video with the programming of an exercise video comprising visual instructions, whereby the visual instructions are selected to comprise a coherent series of non-audio instructions.

13. The process of claim 12, wherein the instruction video is prepared to be viewed in a size viewable on a small screen.

14. The process of claim 13, wherein the small screen is a sub screen portion of larger video display.

15. The process of claim 12, wherein the visual instructions comprise symbols.

16. The process of claim 12, wherein the visual instructions further comprise an indication as to intensity level or an indication as to level of difficulty.

17. The process of claim 15, wherein the indication comprises a color code.

18. The process of claim 12, wherein the visual instructions further comprise a flashing screen or colours to indicate a change in the visual instructions.

19. The process of claim 12, wherein the visual instructions further comprise an indication of the amount of the routine remaining or progress achieved.

20. The process of claim 13, further comprising written instructions in letters which are large in relation to the size of the small screen.

21. The process of claim 20, wherein the written instructions are written in letters which are 20% to 50% in height in proportion to the size of the small screen.

22. The process of claim 21, wherein the written instructions are written in letters which are 20% to 35% in height in proportion to the size of the small screen.

23. The process of claim 12, wherein the exercise video and the first video are broadcast simultaneously as a single program with two views.

24. The process of claim 1, wherein the visual instructions further comprise vibrating or bouncing video displayed on the small screen.

25. The process of claim 1, wherein instructions further comprise vibration of a portable device attached to a body of a user of the exercise video, wherein said portable device provides vibration as a signalling mechanism, said vibration corresponding to an event in said exercise video.

26. An article, comprising: a portable device including a video recording, wherein the video recording is an exercise video incorporating visual instructions into the exercise video, whereby the visual instructions comprise a coherent series of non-audio instructions, wherein the exercise video is displayed simultaneously or in conjunction with audio video content, wherein the visual instructions further comprise vibrating or bouncing video displayed on the small screen.

27. An article of claim 26, wherein the visual instructions further comprise vibration of said portable device attached to a body of a user of the exercise video, wherein said portable device provides vibration as a signalling mechanism, said vibration corresponding to an event in said exercise video.
